(19) United States
(12) Patent Application Publication
(10) Pub. No.: US 2003/0030331 A1
(43) Pub. Date: Feb. 13, 2003

(54) 12 or 36-Volt perpetual motion fan module

(76) Inventor: Rudolph V. Bailey SR., (US)

Correspondence Address: Rudolph V. Bailey Sr., DBA JESUS & Bailey Inc., 938 Shank Road, Dover, DE, 19904, US

(21) Appl. No.: 10/075,569

(22) Filed: Feb. 13, 2002

Related U.S. Application Data
(60) Provisional application No. 60/303,871, filed on Jul. 9, 2001.
(60) Provisional application No. 60/349,731, filed on Jan. 17, 2002.

(51) Int. Cl. H02K 21/00

(52) U.S. Cl. 310/40 MM; 310/152

(57) ABSTRACT

A means for creating perpetual motion of a battery operated fan module has been disclosed. A battery-operated device such as a fan can be operated continuously without interruption for an indefinite period.

This can be accomplished by recycling wasted or unused energy within the device, in such a manner, as to continuously reuse the same energy source eliminating the need for any external energy to keep the said device in operation.

### DESCRIPTION OF RELATED APPLICATIONS

This application is a continuation-in part of Co-pending application Ser. No. 60/336,023 filed Nov. 24, 2001.

### BACKGROUND OF THE INVENTION

This version of the invention is concerned with the field of perpetual motion devices. More specifically, this version of the invention is concerned with a battery operated fan module, which employs a system of recycling unused or wasted energy and using the said energy over and over again to create perpetual motion.

### PRIOR ART

History is replete with man's attempt of design continuous operating apparatus. However, to the best of my knowledge, no previous attempt has succeeded. This leaves open the question as to the possibility of a perpetual motion useful device to serve human kind. While this debate continues to baffle the intellectual community, research continues in this intriguing field. While I cannot cite any successful prior art, I believe, with God's help, I can contribute something meaningful and lasting to human-kind by the development of a useful perpetual motion machine.

The present invention achieves its intended purposes, objects, and advantages through a new, useful and unobvious combination of methods, steps, and component elements with the use of a minimum number of functioning parts at a reasonable cost to manufacture, and by employing only readily available materials.

### SUMMARY

The present version of the invention, which will be described in greater detail hereinafter, relates to the field of perpetual operating devices. More specifically, this version of the invention is concerned with battery operated devices which employs a built in energy recycling mechanism which recycles the energy source as the said device is being used, allowing the device to operate indefinitely without interruption. My version of the invention overcomes all of the shortcomings of previous attempts employing novel aspects that will be described in detail hereinafter.

Described briefly, according to a typical embodiment, the invention presents a portable fan apparatus for moving air for personal comfort of humankind. This device is comprised in general of a base and housing with blade guards. The internal contains three batteries connected in series to give the desired voltage and amps. The drive motor has a shaft protruding from each end. One end of the said shaft has means to operate an energy-recycling component of voltage and amps high enough to recharge the batteries as long as the fan is in operation.

The specific theory of the science of a perpetual motion useful device

JESUS & Bailey states that a perpetual motion useful device can be invented by harnessing wasted or unused energy within a device or system in such a manner, as to re-use the said energy over an indefinite period eliminating the need for any external or additional energy source to operate the said device or system.

No place is this theory more evident than in the standard portable electric fan mechanism. Consider a standard electric fan mechanism where a motor with a shaft directly operates a set of fan blades. While simple to manufacture, the fan mechanism does not make full use of all the energy supplied by the motor; hence, there is wasted or unused energy. The said device does not take into account the benefits offered by using mechanical advantage. One could do more work with the same motor by utilizing gear ratios. To do so would mean one could use a smaller motor to operate the same fan blades. Doing so, however, would cost more to manufacture than using the larger motor.

Take the case of a battery operated fan using the previously mentioned example; one could use the same motor that drives the fan blade and utilizing mechanical advantage—one could also energize a generator which could in turn, recharge the battery. The battery would supply electrical energy, which the motor would convert to turning motion to operate the fan blades; the generator would then convert the unused turning motion back to electrical energy, recycling that energy back to the battery. That process would be continuously repeated creating perpetual motion, and eliminating the need for any new external energy source for the continual operation of device or system.

The Specific Principle of a Perpetual Motion Useful Device or System

Hence, using the previous example when the device is turned on, it would start with a specified value of electrical energy. When the cycle is completed, the fan blades would accomplish the work of moving the air, and the battery would end up with the same value of electrical energy it started with. This would mean in principle that the device would be operating at 100% efficiency, and actually use no energy to perform the said work. A similar example would be as follows: Suppose I bought a barrel of oil for $100.00 and sold it back for $200.00; I would realize $100.00 profit. I could then purchase another barrel of oil with my profit of $100.00. That barrel of oil would in principle cost me nothing. In other words, I would end up with a barrel of free energy. I could repeat that process forever and end up with free energy. In principle, I have invented a way to do the same thing with a machine or device. Accordingly, since the device in principle was 100% efficient, there would be no polluted waste discharged from the device.

This is the specific law governing the perpetual motion useful device or system.

(1) The device or system must be helpful and useful to the benefit of humankind.

(2) The device or system must operate perpetually with no cost for fuel to humankind.

(3) The device or system must not expel waste that is harmful to humans, animal, or the environment or ecology, or waterways.

This science, principle, technology and law will allow humans to travel without the use of fuel and pollution. The fact that one could travel without fuel is especially important since the barbarous acts of Sep. 11, 2001. This technology will open the door for air and spacecraft to fly without the use of fuel.

This science and technology will result in saving lives and money, and will eliminate many health hazards associated with pollution. Land and marine vehicles will also be able to go fuel-less. This science and technology will also free the nation from dependence on imported oil, enhancing the overall economy by allowing consumers to have more money to spend other goods and services.

This principle, science, law and technology will also give consumers free and cheaper utilities as it applies to the generation of electricity. This technology will also lessen the drilling for oil and oil spills.

The benefits afforded by this new science and technology is so overwhelming, it can no longer be dismissed as being impossible, but must be given equal chance for its developments and use in civilization.

My invention, therefore resides not in any one of these features per se, but rather in the particular combination of all of them herein disclosed. It is distinguished from the prior art in these particular combinations of its structures for the uses and functions specified.

In order that the detailed description of invention may be better understood, and that the present contribution to the art can be more fully appreciated, additional features of the invention will be described hereinafter. It should be appreciate by those skilled in the art that the conception and the disclosed specific methods and structures my be readily utilized as a basis for modifying or designing other structures for carrying out the same purposes of the present invention. It should be realized by those skilled in the art, that such equivalent methods and structures do not depart from the spirit and scope of the invention.

In this respect, before explaining at least one embodiment of the invention in detail, it is to be understood that the invention is not limited in its application to the details of construction and to the arrangements of the components set forth in the following description or illustrated in the drawing. The invention is capable of other embodiments, and of being practices and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention.

Further, the purpose of the foregoing abstract is to enable the United States Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application nor is it intended to be limiting as to the scope of the invention in any way.

Accordingly, it is an object of my version of the invention to provide a low cost, easy-to-manufacture, and easy to-market battery operated perpetual motion fan module.

For a better understanding of the invention, its operating advantages and specific objects attained by its uses, reference should be made to the accompanying drawing and descriptive matter in which there is illustrated a preferred embodiment of the invention. The foregoing has outlined some of the more pertinent objects of the invention. These objects should be construed to be merely illustrative of some of the more prominent features and applications of the present invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiment in addition to the scope of the invention illustrated by the accompanying drawing. Furthermore, in the absence of any relevant prior art discovery, I have furnished my version of the science, technology principle and laws and uses governing the present invention. These uses are merely illustrative and should not be regarded as restricting, as other uses also apply falling within the scope of the present disclosure.

### BRIEF DESCRIPTION OF THE DRAWING

The foregoing and other objects, features and advantages of the invention will become more fully understood from the following description of the preferred embodiment of the invention as illustrated in the accompanying drawing. The drawing is not to scale, emphasis instead being placed upon illustrating the principles of the invention.

FIG. 1 is an elevational view of a 36-volt perpetual motion battery operated fan module. The device is viewed with the casing cover removed.

### DESCRIPTION OF THE PREFERRED EMBODIMENT

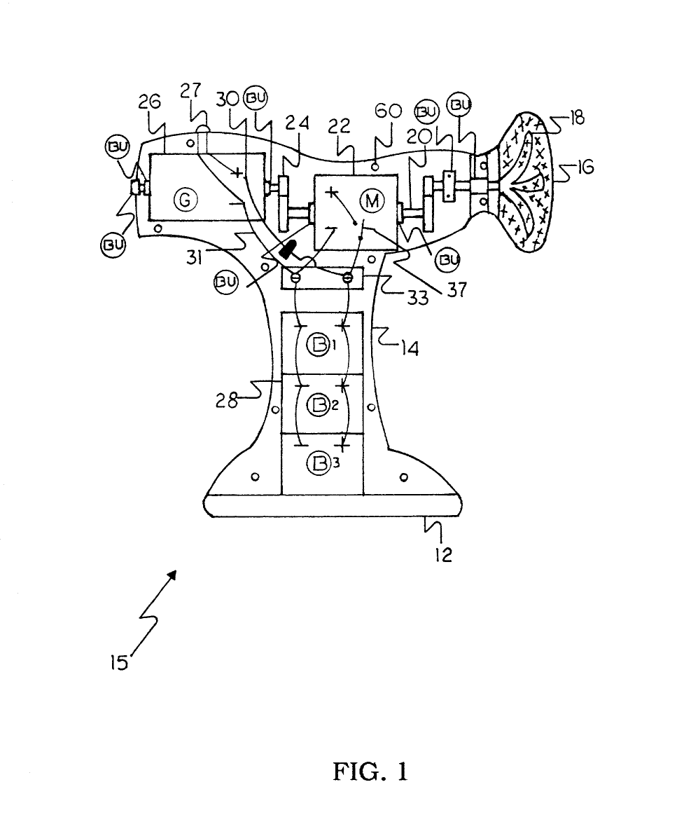

Referring now to the drawing and in particular, to FIG. 1 wherein there is illustrated a typical embodiment of a 36 volt battery operated perpetual motion fan module 15. The present version of the invention 15 is constructed of material and components that are lightweight, durable and resistant to corrosion and oxidation, such as plastic, aluminum, carbon steel, brass, various composite materials or a combination thereof, including the possibilities of conducive polymers. The device 15 consists in the main housing of a base 12, three batteries 28 labeled (B1, B2, B3) and connected in series to give 36 volts. A battery terminal strip 33, a 36-volt motor 22, a 37.5-volt generator 26 and two gear-drive assemblies 24 at either end of motor 22. Seven bushing bearings labeled BU allow smooth and free operation of motor shaft with fan blades 18, and generator 26. When Switch 37 is closed, 36 volts goes to motor 22 that converts the electrical energy from battery 28 to turning motion. Motor shaft 20 and gear assemblies 24 transmits the said turning motion to both fan blades 18, and generator 26 at the same instant. Fan blades 18 performs the desired work of moving the air to provide cooling action for person or persons. Generator 26 then converts the same turning motion back to electrical energy recycling the said electrical energy back to battery 28 via positive wire and voltage regulator 30 and negative wire, 31. This cycle is continuously repeated as long as switch 37 remains in the on position, thereby creating perpetual motion of the said fan blades 18; guard 16 protects blades 18.

### RAMIFICATION CONCLUSION AND SCOPE OF INVENTION

From the foregoing, it will be readily understood by persons skilled in the art that an improved perpetual motion battery operated device has been provided. The invention is relatively simple and easy to manufacture, yet affords a variety of uses. While my description contains many specifications, these should not be construed as limitations on the scope of the invention, but rather as an exemplification of the preferred embodiment thereof. For example, any number, type or voltage of rechargeable batteries could be chosen rather than that which is specified in the present application. The foregoing is considered as illustrative only of the principles of the invention. Further, since numerous modifications and changes will readily occur to those skilled in the art, it is not desired to limit the invention to the exact construction and operation shown and described; accordingly all suitable modifications and equivalents may be resorted to, falling within the scope of the invention. Although this invention has been described in its preferred form with a certain degree of particularity, it is understood that the present disclosure of the preferred form has been made only by way of example, and numerous changes in the details of construction and combination and arrangement of parts may be resorted to without departing from the spirit and scope of the invention.

### DRAWING REFERENCE NUMBERS

12 Fan base

14 Fan housing

16 Blade cover

18 Fan blades

20 Motor shaft

22 36-volt fan motor

24 Motor/generator drive assembly

26 37.5-volt generator with internal sensor switch normally-closed and opeans at 37.5-volts

27 Generator charging light

28 12-volt battery (B1, B2, B3) Wheelchair type

20 Positive lead wire with voltage regulator to prevent over charge

31 Negative lead wire

33 Terminal strip

37 Fan on/off switch

60 Cover plate holes

BU Bushing bearings

1. What I claim is the independent means to create perpetual motion within a device or system without need for any external energy source comprising:
(a) DC motor with one end of drive shaft having means to operate desired moving parts and
(b) Other end of said motor shaft having means to operate a DC charging component with controls and volts and amps high enough to
(c) Charge battery of volts and amps high enough to operate said motor where by said charging component recycles charging energy back to said battery thereby creating perpetual motion of desired moving parts as device is housed in appropriate casing.
